(19) United States
(12) Patent Application Publication
(10) Pub. No.: US 2008/0077784 A1
(43) Pub. Date: Mar. 27, 2008

(54) ELECTRONIC MARKETING ON A COMPUTING DEVICE DURING SELECT TIME WINDOWS

(75) Inventors: Geraldine Robinson, St. Louis, MO (US); Donald Lawrence Clark, Auburn, WA (US); George Washington Graham, Memphis, TN (US)

Correspondence Address: BLACKWELL SANDERS LLP, 720 OLIVE STREET, SUITE 2400, ST. LOUIS, MO, 63101, US

(73) Assignee: GERRI'S MARKETING & ADVERTISING CONCEPTS, LLC, St. Louis, MO (US)

(21) Appl. No.: 11/533,832

(22) Filed: Sep. 21, 2006

(51) Int. Cl. G06F 15/177

(52) U.S. Cl. 713/1

(57) ABSTRACT

An apparatus and method that can be used for marketing and advertising during the system check of a computer, which is one of the busiest periods that the computer or computer type device has, which occurs just before the computer or computer type device initializes its operating system and after power up. The methodology is to run various forms of advertisements/commercials while the computer or computer type device is busy. The present method calls for the advertisements/commercials to run during the time window when the system check is normally displayed at a very rapid pace, and prior to the operating system attempting to engage and run the computing device. While the system check is occurring the present invention calls for advertisements/commercials to run in the foreground covering, if not all, a portion of the monitor screen.

### BACKGROUND OF INVENTION

1. Field of Invention

This invention relates generally to electronic marketing and advertisements and, more particularly, to electronic advertising on computers during select time windows such as for example during computer power-up.

2. Background Art

There are various ways to present advertisement pieces on a computing device to the user, particularly on personal computers (PCs) having access to a wide area network (WAN) such as for example, the internet. For example, an advertiser can include and present advertisements to a user by way of graphical banners, video files or audio files on an internet site to which the user has navigated. An advertiser can also present textual information on a web site or provide the user with a link to another web page containing information about an advertiser or advertised product.

It is also a known method to embed hidden advertisement links within a standard hypertext link, which links the user to a destination internet site. A user can select a link navigating to a destination web site, and in making the selection triggering a masked embedded link, and is briefly shown an advertisement during this waiting time as the computing device navigates to and downloads the destination web page. This type of advertising requires the user to view the advertisement while the browsing device downloads and displays the advertisement. This type of advertising methodology is also used when advertising information embedded in a web page or in the home page of the browser, or cached in the client browsing device itself, and is presented in response to selection of a hypertext link on a web page.

However the above methods can be problematic and troublesome to the user because in the age of high-speed internet access, browsing from web site to web site has become faster and faster thereby reducing the time window to advertise and further artificially delaying the browse time by showing the advertisement. These advertising methods can also delay the user by downloading the advertising information. Further the above advertisement opportunities are strictly tied to the browser application, thereby burdening the browser functionality and requiring the advertisement function to monitor the status of the browser application to determine when an advertisement can be displayed.

Also with the above methodology, the user must direct the browsing device to download the information by selecting a link. Also, in the case where a computer automatically accesses the WAN to download information, the problem still remains with the browser waiting time as outlined above. Internet access services face several problems when advertising. The above is not an effective means of distributing advertising for Internet access services. The user typically uses a modem to establish a connection to the internet, and uses an off-the-shelf browser program to access web pages through the Internet. However in cases where the user is not utilizing the browser function, the methodology above cannot be used to distribute advertising to a user of such an internet access service because the user is not accessing any web pages. The above methodology requires the user to initiate some action beyond what the user would normally perform during normal use of the computing device.

Other Internet access services, such as the WEBTV Internet access network and DSL, offer Internet access via a proprietary interface allowing access to subscriber services, such as a web directory and search engine, as well as to the Internet. The above technology can also be utilized to advertise directly to users of such an internet access service, but only when the users are accessing certain web pages as determined by the internet access service. However, the above Internet service methodology is very much tied to the browser application of the internet access provider.

When a browsing device is directed to a different site from that determined by the internet access provider, the internet browser application must resort to technology where a server pushes information to a browsing device without request from the user, or based on a preset request from the user. However with this type of technology, the user can experience two types of delay. First, the user can experience a delay as the browsing device takes time to download the information. Second, the user can be delayed when interrupted by pushed information. Such delay may be annoying to the user, and may decrease the receptiveness of the user to the advertisement.

A system is needed where the browser function is not burdened with additional delays and the advertisement methodology is not based on a browser application waiting time and where the user does not have to intentionally initiate the down load of advertisement data by some action beyond the user's normal usage. Current browsing applications can have user delay and wait, but a system is needed that does not rely on this anomaly. In addition, a browsing device may appear to stall while performing internal operations, such as erasing cached files. Finally, the browsing device may experience delay when connecting to external devices and remote computers via a communications network. These inherent delays in using the browsing applications further reduces the appeal to the user to navigate the web and adding advertisement functions that rely on these waiting period simply makes the problem worse.

It would be desirable to provide a method for presenting advertisement data wherein data is downloaded without user initiation and presented to the user without relying on browsing application waiting windows and is not triggered by user inputs or selection to the browser interface. Users typically experience delay during power up. The present invention can address these time windows.

### BRIEF SUMMARY OF INVENTION

The invention is a method that can be used for marketing and advertising during the system check of a computer, which is one of the busiest periods that the computer or computing device has, which occurs just before the computer or computing device initializes its operating system and after power up. This system check is similar to that which occurs in many computerized systems, which allows for a system check thereby determining if the system is ready to commence normal operation. For instance, when a computer or computer type device is first powered up, it goes through a test for computer or computer type device power validation and a check for the minimum components needed for a computer or computer type device to operate. This basic system check includes an input and output check to verify basic computer or computer type device communication. For most personal computers (PCs), spurious information relating to the system check is presented on a display monitor during this time window. This spurious information appears on and vanishes from the display very quickly such that the user will likely not be able to read the information in any detail and most users are not interested in reading the information.

Most of the passive internet marketing concepts center on “Idle Time” marketing or “Waiting time at start-up” marketing. The aforementioned internet marketing concepts require that the operating system (OS) is engaged and operational for user interface such that it can be determined when the browser is not in use. The present invention's marketing methodology is not related to the use or non-use of the browser but simply to the system check. The methodology is to run various forms of advertisements/commercials while the computer or computer type device is actually busy performing various system checks and tests. The present method calls for the advertisements/commercials to run while the computer or computer type device is actively doing its system check. The system check is normally displayed on the screen at a very rapid pace, and when the system check is done the operating system is initiated and attempts to engage and run the computer or computer type device. While the system check is occurring the present invention calls for advertisements/commercials to run in the foreground covering, if not all, a portion of the monitor screen, while the computer is busy completing its checks.

In a typical computing system or personal computer there clearly is a technical difference between the hardware electronics and software programs of computers or computer type devices. The responsibilities are divided into hardware design and software applications. For example, computers are designed such that the hardware components can seamlessly communicate with the operating systems and its applications. Many hardware components have embedded code and counters that allow it to communicate in machine language, which is a series of bits of ones and zero's. The present invention or methodology focuses on additional hardware instructions to aid in additional channels of communication and advertisements. The additional instructions can become part of the BIOS of the components embedded code that is called device drivers, or firmware.

The API (Application Programming Interface) portion of the present invention examines the different opportunities that commercials can be loaded into the operating system and the various BIOS (Basic Input Output System) configurations. The BIOS is a set of instructions usually stored on a ROM chip inside a typical personal computer, which handles all input-output functions. The origin of an API can be from various sources. An API is an interface between the operating system and application programs, which includes the way the application programs communicate with the operating system, and the services the operating system makes available to the programs. For example, an API may make it possible for programs that run under it to open windows and display message boxes. API's can be administered from many different avenues including CD's, file downloads, software installations, driver modifications and video and music downloads. Hidden API's can allow commercials to be downloaded from the Internet while the computer or computer type device is actively performing other operations.

Hidden APIs can allow commercial/advertisement files to be downloaded in the background from the internet when the operating system and other application are actively performing tasks and operations in the foreground. Alternatively the user can download information media files (such as for example commercial/advertisement files) from a storage media such as a CD ROM. The commercial/advertisement file can also be downloaded as part of an application install when a user installs a new application to a computer. The file can be downloaded into the system BIOS and can reside there dormant until the computing device is powered up. After power up during the system check, the commercial/advertisement file can be played in the foreground rather than the typical system check information. Once the system check is complete and the operating system is initiated the commercial/advertisement can be stopped. Hidden API's can also store the information media files in other peripheral device inactive memory locations. Alternatively, the BIOS itself without the use of API functionality can initiate and perform the download and subsequent displaying of the information media files.

When referring to computer(s) herein when describing the present invention, the term computer includes computer type device(s) including for example PC's and Personal Data Assistants (PDA's). When referring to commercial(s), when describing the present invention the term commercials includes all types of advertisement(s) including video, still images, graphics, windows and banners. These and other advantageous features of the present invention will be in part apparent and in part pointed out herein below.

### BRIEF DESCRIPTION OF THE DRAWING

For a better understanding of the present invention, reference may be made to the accompanying drawing in which:

FIG. 1 is a top level diagram showing the download of the information media file and displaying the file;

FIG. 2 is an illustration of a computing device power up process;

FIGS. 3A-3I are an illustration of the BIOS and POST system check;

FIGS. 4A and 4B is an illustration of the Boot-Up BIOS based file download and commercial display methodology;

FIG. 5 is an illustration of the API based file download and commercial display methodology;

FIGS. 6A and 6B is an illustration of a combination BIOS and API file download and commercial display methodology; and

FIG. 7 is an illustration of Internet Access capability triggered at boot-up.

### DETAILED DESCRIPTION OF INVENTION

There are three methods that are being proposed as part of the present invention. They are (1) use of the BIOS and the BIOS chip, (2) use of the OS by using APIs, and (3) using a combination of using the BIOS and the OS by using APIs. The focus of the present advertising invention process relies on BIOS (Basic Input Output System) redirection configuration, and API (Application Programming Interface) that uses a programming interface to create multimedia applications like Flash Media.

The BIOS (Basic input/output system) is firmware that controls much of a computer's input/output functions, such as communication with the floppy drive, RAM (Random Access Memory) chips, and the monitor. The BIOS is the built-in software that determines what a computer can do without accessing programs from a disk. For example, with PCs, the BIOS contains all the code required to control the keyboard, display screen, disk drives, serial communications, and a number of miscellaneous functions. The BIOS can typically be placed in a ROM chip that comes with the computer (it is often called a ROM BIOS). This ensures that the BIOS will always be available and will not be damaged by disk failures. It also makes it possible for a computer to boot itself. However, RAM is faster than ROM, therefore, many computer designs are such that the BIOS is copied from ROM to RAM each time the computer is booted. This is known as shadowing.

Many modem PCs have a flash BIOS, which means the BIOS has been recorded on a flash memory chip, for example, electronically erasable programmable read only memory which can be updated if necessary. Many computers contain the BIOS information in electronically erasable programmable read-only memory (EEPROM). Therefore, the firmware on the BIOS chips can be modified. It can also be known as flash EEPROM. When modifying the firmware, it can typically be referred to as flashing the BIOS. The PC BIOS is fairly standardized, so all PCs are similar at this level (although there are different BIOS versions). For DOS (disk operating system) based systems additional DOS functions are usually added through software modules. This means you can upgrade to a newer version of DOS without changing the BIOS. PC BIOSs that can handle Plug-and-Play (PnP) devices are known as PnP BIOSs, or PnP-aware BIOSs. These BIOSs are typically implemented with flash memory rather than ROM. Therefore, flash memory is quite common which facilitates the implementation of the present invention.

When the computer is first powered on, it checks these processes and interfaces by way of a system check. At power up the computer does a power-on-self-test (POST). This is when the computer verifies that it has the proper voltages. Power On Self Test Or POST is a test that a computer, for example a personal computer (PC) performs on its hardware, CPU, and memory when the power is switched on. POST is the common term for a computer's, router's or printer's pre-boot sequence. The same basic sequence is present on all computer architectures. It is the first step of the more general process called initial program load (IPL), booting, or bootstrapping. The term POST has become popular in association with and as a result of the proliferation of the PC. It can be used when referring to the code that controls the pre-boot phase or when referring to the phase itself. It can also be used when referring to the code or the system as it progresses through the pre-boot phase.

For a typical PC, the main duties of POST are handled by the BIOS, which may hand some of these duties to other programs designed to initialize very specific peripheral devices, notably for video and Small Computer System Interface (SCSI) initialization. These other duty-specific programs are generally known collectively as option ROMs or individually as the video BIOS, SCSI BIOS, etc. The principal duties of the main BIOS during POST are as follows: 1.) verify the integrity of the BIOS code itself; 2.) determine the reason POST is being executed; 3.) find, size, and verify system main memory; 4.) discover, initialize, and catalog all system buses and devices; 5.) pass control to other specialized BIOSes (if and when required); 6.) provide a user interface for systems configuration; 7.) identify, organize, and select which devices are available for booting; and 8.) construct whatever system environment that is required by the target OS.

The BIOS will begin its POST duties when the CPU is reset. The first memory location the CPU tries to execute is known as the reset vector. In the case of a hard reboot, a code fetch (request) is directed to the BIOS located on the system flash memory. For a warm boot, the BIOS will be located in the proper place in RAM and the reset vector call to the RAM is directed.

During the POST flow of a contemporary BIOS, one of the first things a BIOS should do is determine the reason it is executing. For a cold boot, for example, it may need to execute all of its functionality. If, however, the system supports power savings or quick boot methods, the BIOS may be able to circumvent the standard POST device discovery, and simply program the devices from a preloaded system device table. The POST flow for the PC has developed from a very simple, straightforward process to one that is complex. During POST, the BIOS must integrate competing, evolving, and even mutually exclusive standards and initiatives for the matrix of hardware and OSs the PC is expected to support. However, the average user still knows the POST and BIOS only through its simple visible memory test and setup screen.

Delivery of a commercial can occur concurrently with the next step after POST, which is a basic input and output (BIOS) check. During this check the computer is verifying that it can communicate to specific hardware components like the CPU (central Processing Unit), keyboard, monitor and etc. It is during this phase that we can instruct the computer to begin advertisements. While the BIOS system check instructions are being executed the commercial/advertisement file can be displayed concurrently in the foreground from a previously embedded information media file and/or the computer system can be instructed to initiate an internet connection to retrieve an information media file.

The computer system board contains the BIOS configuration. The BIOS chip can be modified to do additional instructions during its system checks. The BIOS chip configuration can be designed to verify the Network Interface Component (NIC) is present on the system board. The NIC card that connects to the system board and to the Ethernet cable that connects to the Internet. During this system check time the BIOS can implement instructions so that immediate internet connections can be made to a predetermined Internet address. This connection can allow information media files (such as for example commercial/advertisement files) to be immediately downloaded for display.

The BIOS can also be designed to display images through the video card to the monitor resulting from the immediate connection to the Internet address or from previous connections to the Internet address where data has been downloaded. These processes can happen in milliseconds.

Prior delivery or presentation of commercial/advertisement, the proposed invention can use the BIOS chip to execute commercial application delivery methods delivered through the BIOS configuration program designed to connect to the Internet, access a multimedia commercial server and download information media files for example commercial video clips. This procedure of updating the BIOS is commonly known as Flashing the BIOS or Flash ROM (Read Only Memory). ROM contains the default programming information loaded into memory. This can be the area where commercials at system checks can be launched and where new commercials can be downloaded (Flashed into BIOS or ROM).

The advertisement files have different areas in which it can reside until the computer power is turned on again. Depending on what methodology is utilized it can reside in the (1) network interface card, (2) video card, and (3) the BIOS CMOS chip which is a chip that can maintain the devices current configuration. It does not need the computers electrical charge to retain the modifications to the BIOS. The CMOS chip contains a battery so that changes are never lost. It is used on system boards to remember hardware configuration information such as the presence of a hard drive, floppy drive or CD-ROM drive. The Video card, the NIC card and the System board have memory that is capable of saving and displaying files, especially the video card and the system board, and these memory locations can be accessed by the BIOS for displaying. These peripheral device memory locations can be used when the API/OS methodology is utilized.

After the computer finishes its BIOS checks, it locates on the hard drive the operating system executable file and loads the operating system, for example WINDOWS XP, and the operating system takes charge of the computer. At this point commercial(s)/advertisement(s) can end just prior to initiation of the operating system and hand the control of the computer over to the operating system which then starts up the computer or computer type device.

As an alternative methodology to the BIOS only methodology, the commercial/advertisement file can be integrated into the OS by the APIs which can be the medium in which the commercials and advertisements are delivered and loaded into the operating system. APIs have the capability of being embedded into all kinds of software. The APIs are small programs that allow other applications like games to work with the operating system and hardware. An API is the interface that a computer system, library or application provides in order to allow requests for services to be made of it by other computer programs, and/or to allow data to be exchanged between them.

One of the primary purposes of an API is to describe how computer applications and software developers may access a set of (usually third party) functions (for example, within a library) without requiring access to the source code of the functions or library, or requiring a detailed understanding of the functions' internal workings. The software which provides the functionality described by the API is said to be an implementation of the API. The API itself is abstract, as it is an interface. A reference implementation of an API is the implementation created by the designer of the API, or one which other implementations of the API are expected to be compared against.

For example, an API might describe how an application may call an icon-drawing function within a graphics library, for displaying icons in the screen. A programmer can write a program which calls the icon-drawing function described in the API. When compiled the compiler will link against the API. When executed, the program will use the implementation of the API (a library) to draw the icon. Computer programs often use the operating system's API to allocate memory and access files. Many types of systems and applications provide and implement APIs, such as graphics systems, databases, networks, web services, and even some computer games. In many instances, an API is often a part of a Software development kit (SDK). An SDK may include an API as well as other tools and perhaps even some hardware, so the two terms are not strictly interchangeable.

There are various design models for APIs. Interfaces intended for the fastest execution often consist of sets of functions, procedures, variables and data structures. However, other models exist as well, such as the interpreter used to evaluate expressions in ECMAScript/JavaScript or in the abstraction layer, which relieves the programmer from needing to know how the functions of the API relate to the lower levels of abstraction. This makes it possible to redesign or improve the functions within the API without breaking code that relies on it.

The commercial/advertisement APIs can be designed to work with the common Operating Systems, like XP, 2000, 98, MAC and the like. APIs can be embedded software contained within other applications. For example, a computer game can be played on a computer and once the game has completed, it can leave embedded software on your computer to do anything that you want it to do. Since the commercial applications can be working within the confines of the OS, it won't have problems allocating memory, executing and playing the commercials. Since the APIs are accepted by the Operating System, it can be allowed by the operating system to modify the commercial applications so that it can use more or less of the systems resources. This means that the APIs have the capability of modifying any of the system BIOSs. The commercial applications can be programmed to execute during system checks after power up, when normally a series of BIOS statistics would appear.

The method of loading the API into the operating system can be implemented using different methods. For example, one method could require a gaming application (or other application) to be loaded onto the operating system by the user. After the game is played, it can leave embedded software in the operating system that can monitor the users shopping habits and send commercials based on that information. Retail stores may want to take advantage of the commercial opportunities by loading API commercials that promote their interest too. Once the API's are installed, they can link to an Internet based multimedia commercial server and download designated information media files (such as for example commercials) to update commercial changes and to upload any consumer interest in the background without interference to the user. This method of delivering commercials can be automatically done without user intervention but while the computer or computer type device is busy and is not in a period of non-use. Commercials can be downloaded from the Internet while the computer or computer type device is actively performing other operations.

Once downloaded these commercials can be put into peripheral device inactive memory such as within the Video Card, thereby modifying the Video Card's BIOS. These commercials and network links can lie dormant in main memory BIOS or within secondary memory peripheral device locations like the AGP (Video) card or the NIC (network interface card) until there is a system check or any other designated times. Then the computer can run the different types of commercials it has downloaded. The applications being used and manipulated by the operating system can also update the hardware BIOS information, such as changing commercials and playing them. Therefore the API methodology can utilize peripheral device inactive memory without utilizing the main BIOS or the API can utilize the BIOS to store and display information media files therefore resulting in the combination API and BIOS methodology.

One embodiment of the present invention is a computing device comprising a system BIOS including an information media file and display code executable at power up of the computing device where when said display code is executed at power up said display code functions to display the information media file on a monitor of the computing device in the foreground for user viewing during a BIOS/POST system time window and said display code further functions to cease displaying the information media file just prior initiating an OS of the computing device. The system BIOS of this embodiment can also include download code executable in the background during normal operation of the OS of the computing device where when said download code is executed in the background said download code controls the computing device to access a multimedia server remotely located with respect to the computing device and communicably linked to the computing device over a network and said download code controls the computing device to download information media files residing on the multimedia server.

Another embodiment of the present invention is a computing device comprising an API integral with an OS having executable access code and display code that is executable at power up of the computing device where when said API access code is executed at power up, an information media file stored in an inactive storage location of a peripheral device is accessed by the API and when said display code is executed the information media file is displayed just prior to initiating the OS of the computing device. This embodiment can also have an API, which includes executable download code that is executable in the background during normal operation of the computing device where when said download code is executed the API controls the computing device to access a multimedia server remotely located with respect to the computing device over a network and said download code controls the computing device to download the information media file residing on the multimedia server.

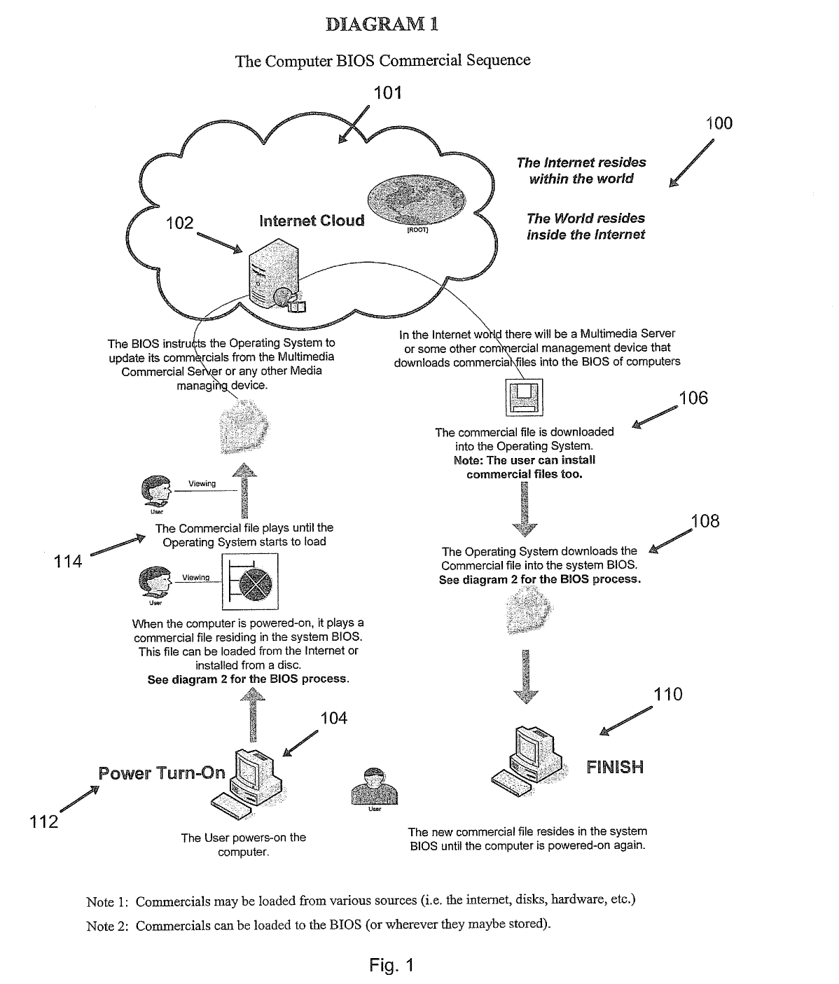

According to the embodiment(s) of the present invention, various views are illustrated in FIG. 1-6 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present invention comprising a combination BIOS/API based commercial/advertisement file download and display system 100 teaches a novel apparatus and method for electronic marketing on a computer during select time windows. The details of the invention and various embodiments can be better understood by referring to the figures of the drawing. Referring to FIG. 1, a top level diagram showing the downloading of a file and displaying for user viewing is shown. An information media file server (multimedia commercial server) 102 can be remotely located from and communicably linked to a user's computing device 104. The multimedia commercial server can have residing thereon various commercial/advertisement data files containing data or information that can be displayed on the monitor of the computing device. The multimedia commercial server can be communicably linked to a user's computing device over a local area network (LAN) or a wide area network (WAN). For example, the multimedia commercial server 102 can be communicably linked to the user's computer 104 over a wide area network such as the Internet 101. The multimedia commercial server can be accessed by utilizing its URL address. The user's computer 104 can interface through an internet service provider with the multimedia commercial server. WANs of this type are well known in the art. Located within the WAN, there will be a multimedia server or some other comparable management device that is operable to provide and download commercial/advertisement files to the user's computer.

The diagram shown in FIG. 1 illustrates utilizing a combination of an API and BIOS to download an information data file, such as for example, a commercial/advertisement file, such that downloading the information file is into the BIOS systems files. This combination of utilizing the API and the BIOS systems files is one embodiment of the present invention. However, this same functionality of downloading and subsequent displaying of the information data file can be performed solely by the API or alternatively solely by the system BIOS. If the API is utilized as a stand alone method, then the information data file can be stored in various different memory devices as indicated above. Alternatively, if the system files is utilized solely then the system BIOS can contain program instructions that allows the computer to access the multimedia commercial server to download information files into the BIOS by way of flash memory.

Specifically, referring to FIG. 1, the information data file is downloaded by utilizing the API methodology 106. The API downloads the information file into the system BIOS 108. This operation can be performed in the background while the user is performing other functions. This operation can be initiated without any specific user input and further can be performed without the user being aware of the download. When the download is complete 110, the newly downloaded information files can reside in the system BIOS until the computer is powered on again. When the user powers on 112 the computer device 104, the BIOS/POST system check is initiated. During this system check time window the information file residing in the system BIOS is loaded and played for user viewing 114. The information file displayed to the user can be the most recently downloaded information file.

As an alternative embodiment, multiple information files can be downloaded at a given time during operations 106 and 108. If multiple files are downloaded at a given time, the playback scheme can be such that the information files are cycled in sequence or randomly for displaying during the display time window. Further, an alternative embodiment could include the ability of the user to download information files from an electronic storage media, such as for example a CD, rather than downloading information files from a multimedia commercial server. The information file can continue to be displayed during the system check but will cease just prior initiation of the operating system. At this time, the operating system can be instructed to update the information files by downloading additional information data files from the multimedia commercial server.

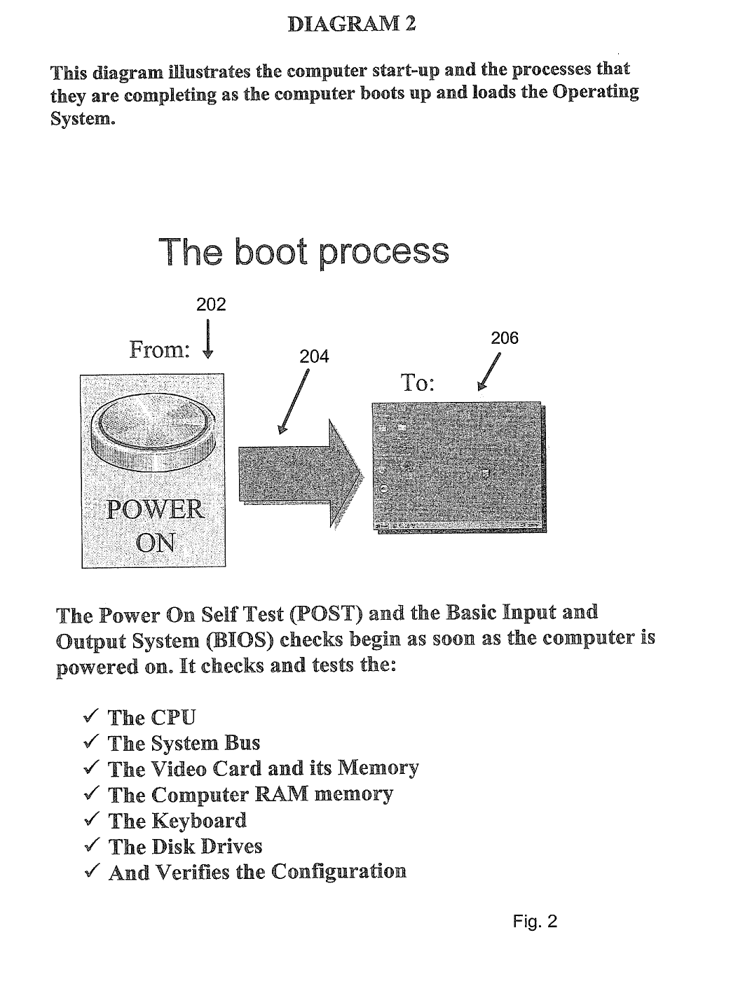

Referring to FIG. 2, an illustration of a computing device power up process is shown. The diagram in FIG. 1 illustrates the computer power up and the system check process and the loading of the operating system. The BIOS/POST system checks are initiated when the computer is powered up by the user 202. During the system check time window 204, various system checks are performed including the CPU, the system bus, the video card and its memory, the computer RAM memory, the keyboard, the disc drives and various other systems checks. Further during this time window, the computer performs various configuration checks. When the system check time window 204 is completed, the operating system is initiated 206. It is during this time window 204 that the information files are displayed to the user.

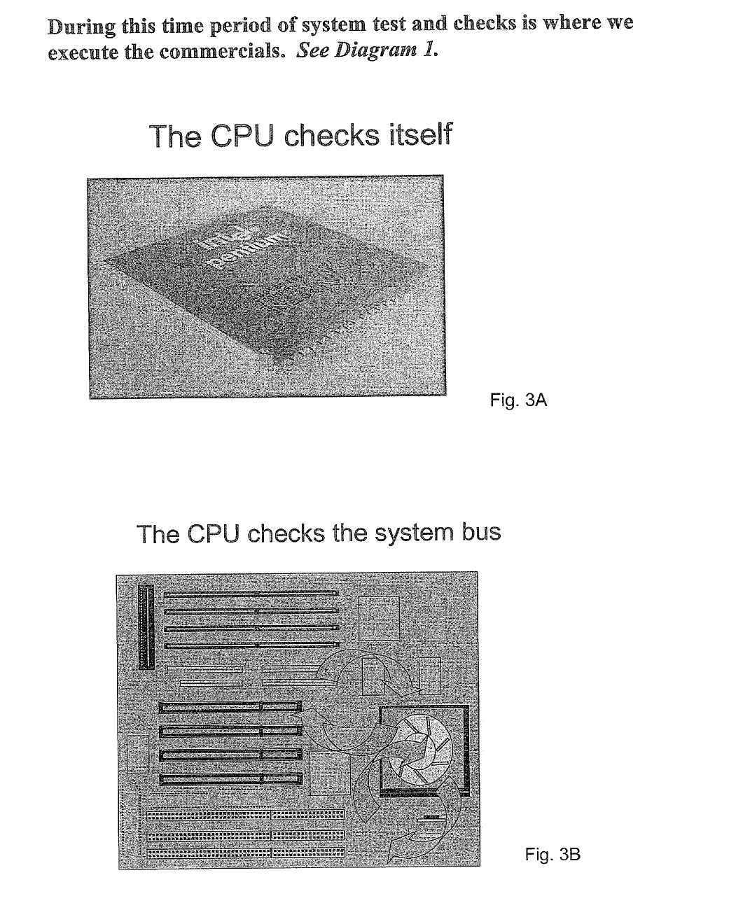

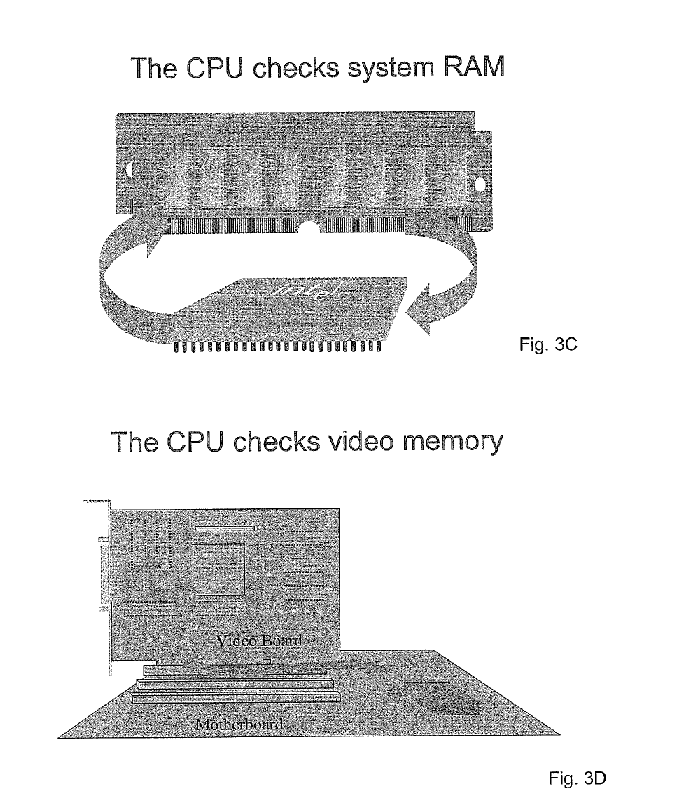

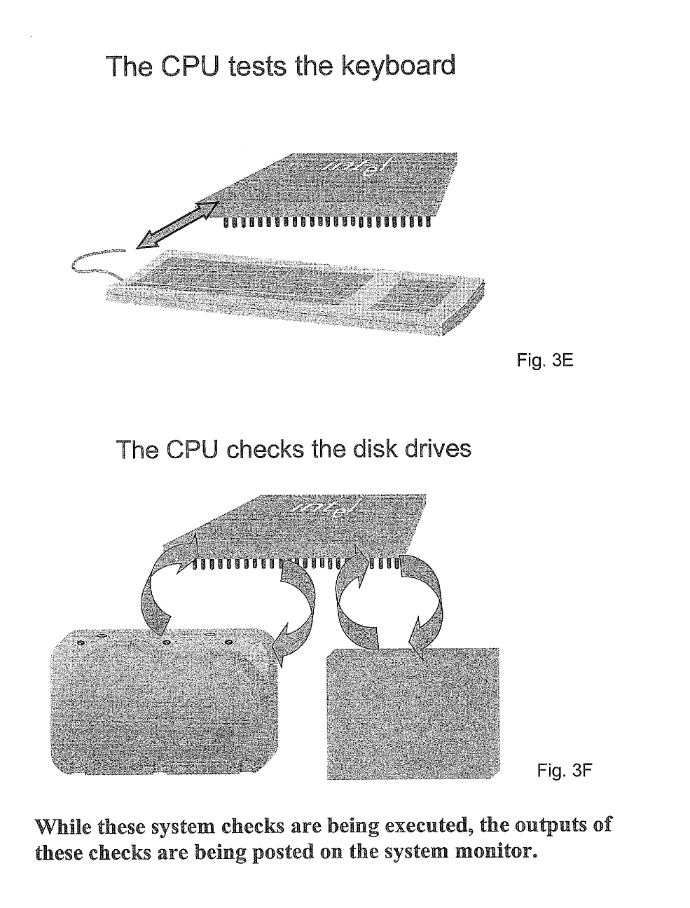

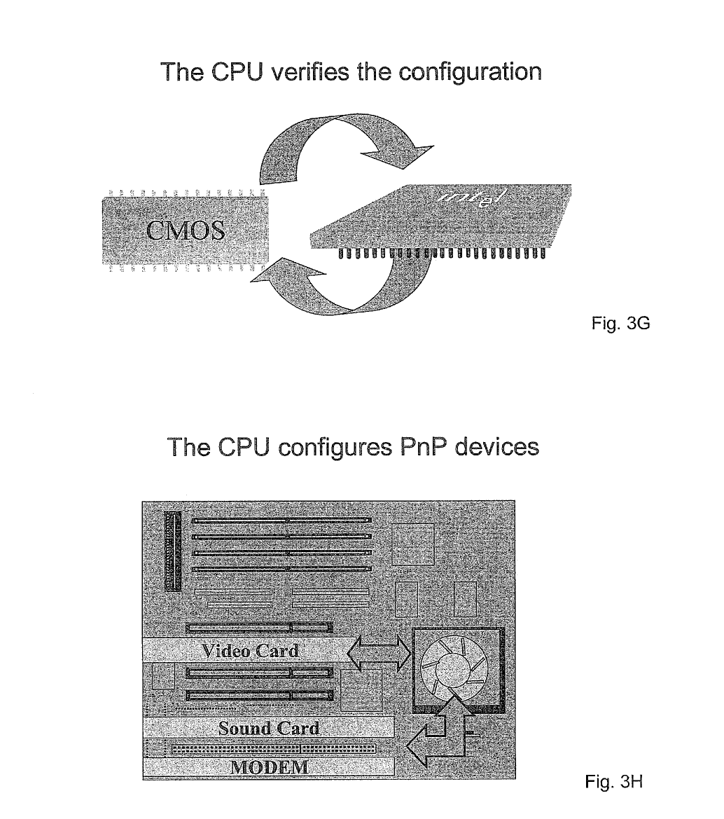

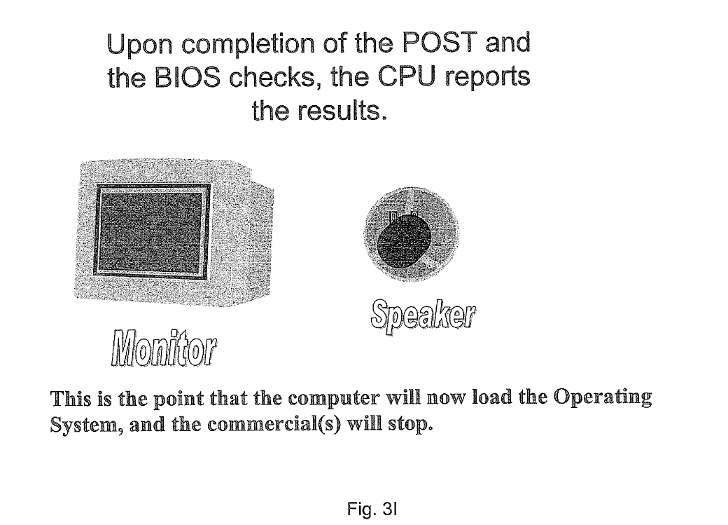

FIGS. 3A through 31 are illustrative of the various BIOS/POST system checks that are performed during the system check time window. The computing device is obviously not idle during these various system checks as the BIOS/POST system check is actively exercising the various interfaces and establishing the appropriate configuration for the operating system. As these various system checks are being performed the information files can be displayed to the user in the foreground rather than the spurious status relating to the system check results.

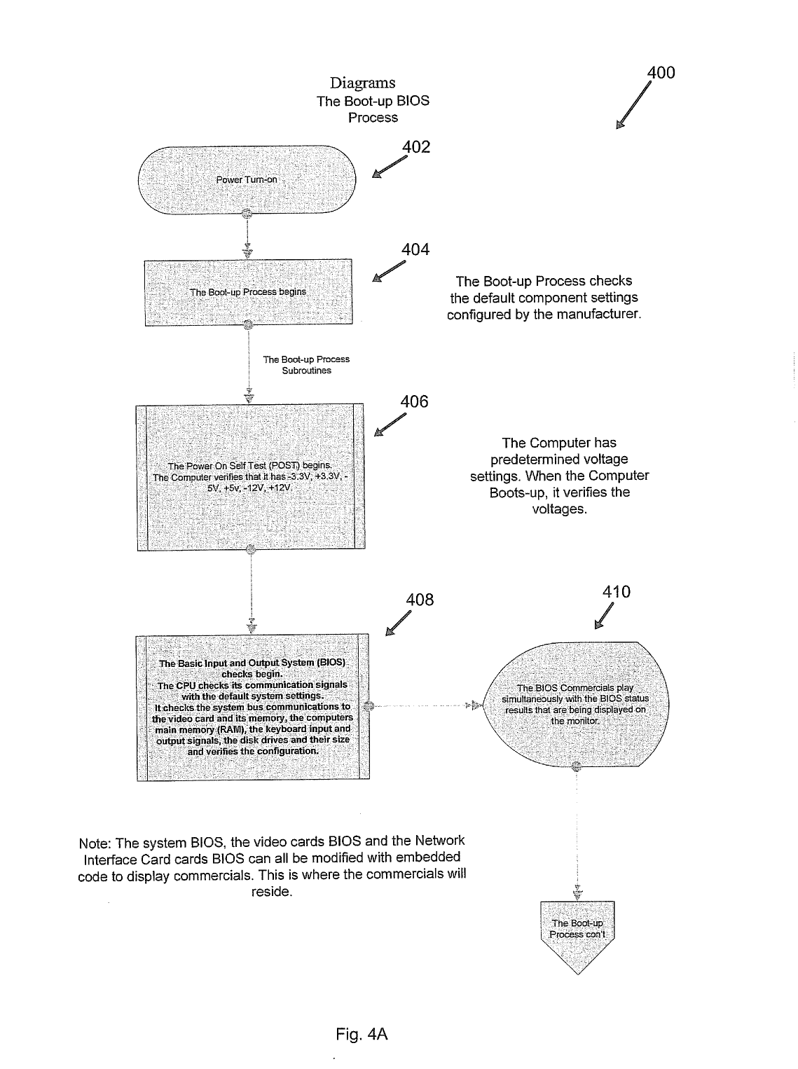

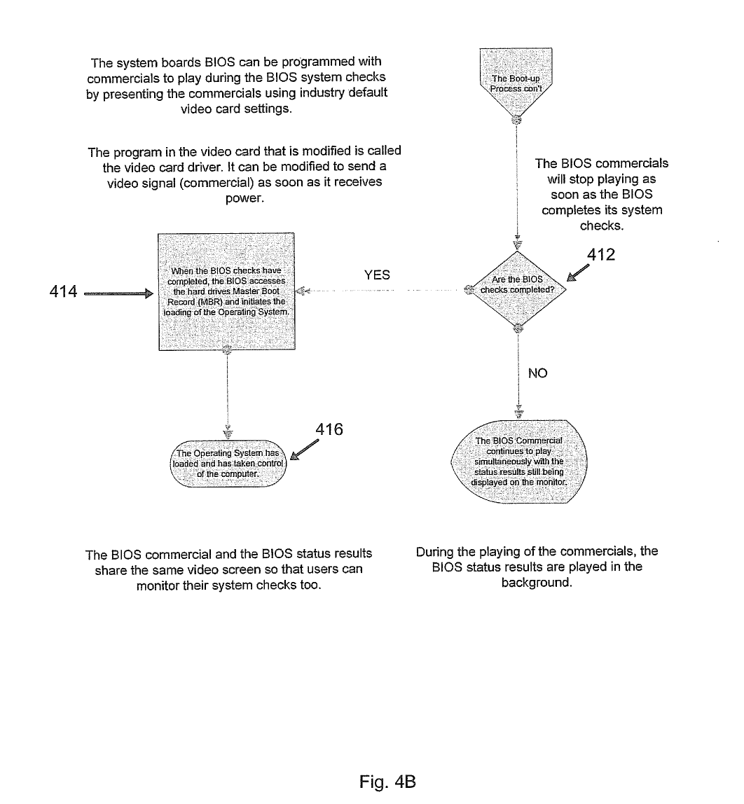

Referring to FIGS. 4A and 4B an illustrative example is provided showing an example process flow for a boot-up BIOS based file download and commercial display methodology 400. At power-up 402 of a computing system, for example, a personal computer, the boot-up process 404 begins. The boot-up process begins by checking the default component settings configured by the manufacturer of the computing system. The boot-up process server teams are initiated 406 such as for example the power on self test. The computer can have predetermined voltage settings whereby when the computer boots up the voltages are verified. The BIOS system checks can begin as reflected by functional block 408 during which time window the CPU can check its communication signals with the default system settings. The BIOS system check can also verify and check the bus communications to the various peripheral circuit cards such as the video card and its memory. The BIOS system check can also check the random access memory (RAM) as well as the keyboard imput and output signals, the disc drives and their various configurations. The basic system BIOS can be modified with the necessary embedded code such that when the code is executed it can be operable to retrieve and store information media files as well as display media files that have already been stored. In addition to the basic system BIOS being modified, other peripheral BIOSes can be modified such as for example the video card BIOS, and the network interface card BIOS. The information media files can reside in the BIOSes as well as the necessary code such that when it is executed is able to retrieve and store the information media files as well as display them. The BIOSes can be modified or updated utilizing methods well known in the art area, such as for example, a run time executable file configured to install executable code into the BIOS.

During the time when the BIOS system checks are occurring, the BIOS information media files can be displayed simultaneously 410 on the computing systems' monitor. The information media files or commercials can be played on the display monitor in the foreground completely overlaying the spurious BIOS status information or alternatively, can be displayed in a window while allowing the BIOS status results to be displayed simultaneously. The playback for displaying of the information media files continues throughout the boot-up process. The system boards BIOS can be programmed with commercial or information media files to playback or display during the BIOS system checks by presenting the commercials or information media files utilizing industry default video card settings. The program in the video card that is modified can typically be called or referred to as the video card driver or firmware. This code can be modified to send the video signal to display on the monitor as soon as the boot-up process begins.

The modified code can continuously monitor to check to see if the system BIOS checks are completed 412. When the BIOS system checks are completed 414, the BIOS accesses the hard drive's master boot record (MBR) and initiates the loading of the operating system. The displaying or presentation of the information media files or commercials on the display monitor of the computing system will cease when the operating system is initiated 416. As discussed above, during the BIOS system check the BIOS embedded information media file and the BIOS status results can share the same video screen so that the users can monitor their system checks while viewing the information media file. Or alternatively, the BIOS status results can be displayed in the background.

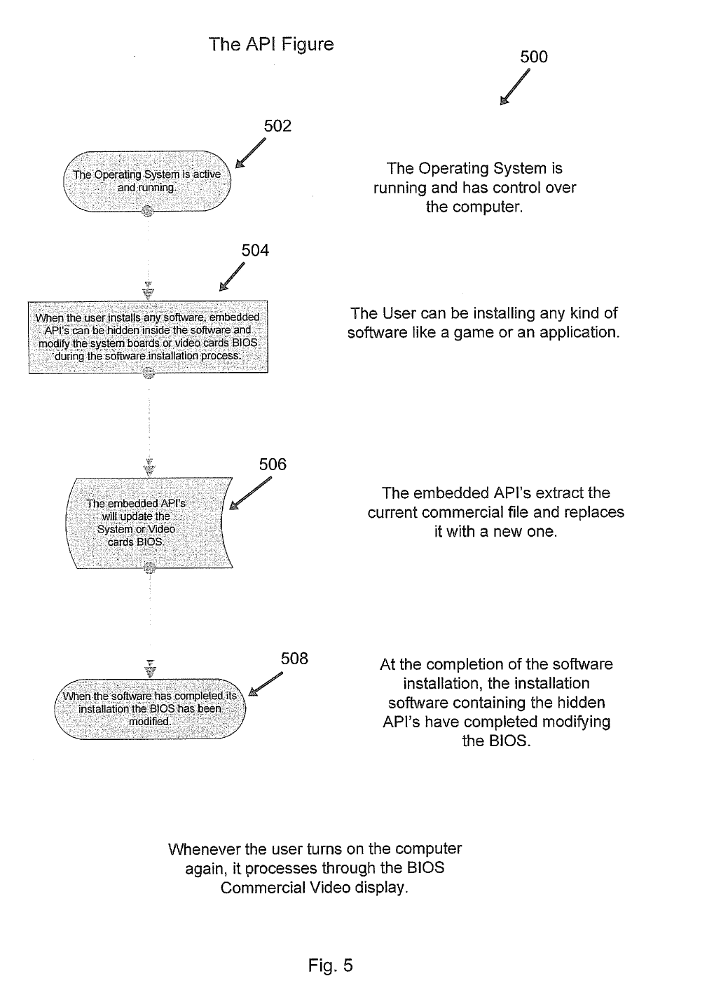

Referring to FIG. 5, an illustrative example of an API based file download and commercial display methodology is shown. One method implementing the API based file download and commercial display methodology is to install the necessary code on the computing system while the operating system is active and running 502. For example, when a user is installing any software 504, embedded within the software can be APIs hidden inside the software that is operable to modify BIOS system boards or the BIOS of peripheral cards such as the video card where the installation occurs during the software installation process. This can be accomplished when the user is installing any kind of software application including games or other applications. The embedded APIs can update 506 the basic system files or for example a video card BIOS. Further, the embedded APIs can be designed to extract the current information media file or commercial file and replace it with a new one. The embedded APIs can be designed to be operable to access and retrieve media files from a multi-media commercial server as well as from other data sources. When the software installation is complete 508 the BIOS can be modified. The installation software containing the hidden API can be designed to complete the modification of the BIOS as desired. The installation of the software having embedded APIs can be installed by way of various means well known in the art including installation via a run time executable installation application being stored on and executed from an electronic storage media such as a floppy disk or CD rom.

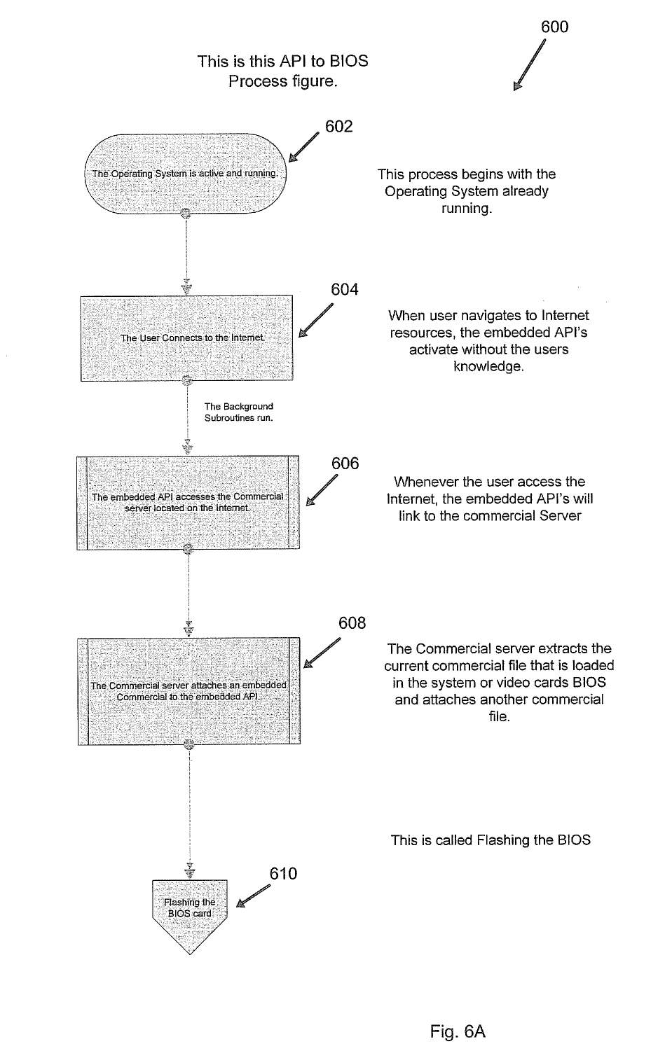

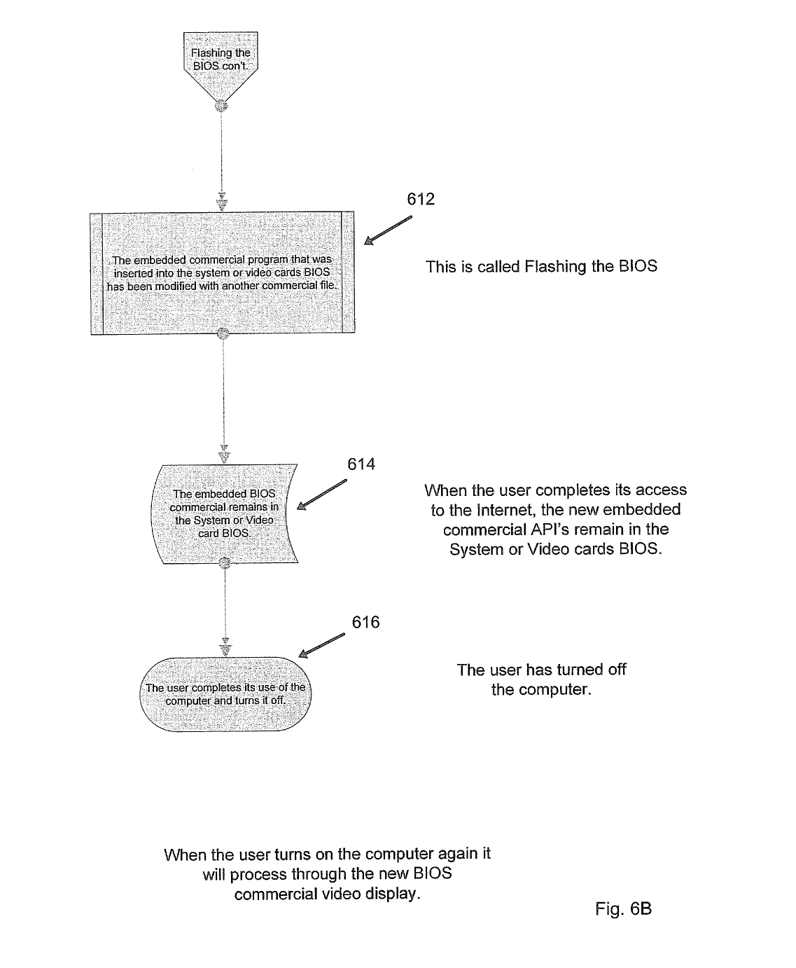

Referring to FIGS. 6A and 6B an illustrative example of a combination API and BIOS file download and commercial display methodology is shown. As before, the process can begin when the operating system is active 602. A user of computing system can connect to the internet 604 by utilizing a browser application. When the user accesses the internet, the embedded APIs can be designed to be activated without the user's knowledge. Whenever the user accesses the internet, the embedded APIs can be designed to link to the commercial information media server in order to download information media files as reflected by functional blocks 606 and 608. The commercial information media server can provide new information media files. The currently loaded information media files can be extracted and new ones provided. The information media file can be flashed or programmed onto the BIOS card 610. Once the embedded information media file has been inserted into the BIOS 612 the information media file can reside there 614 until the system BIOS check is initiated. When the user completes access to the internet, the newly embedded commercial APIs remain in the system or video cards files or alternatively in the main system BIOS. The user can then complete whatever necessary task on the computer and then turn off the computer or at least log off the computer. When the user logs on or turns on the computer again it will process through the new BIOS thereby displaying the commercial video file.

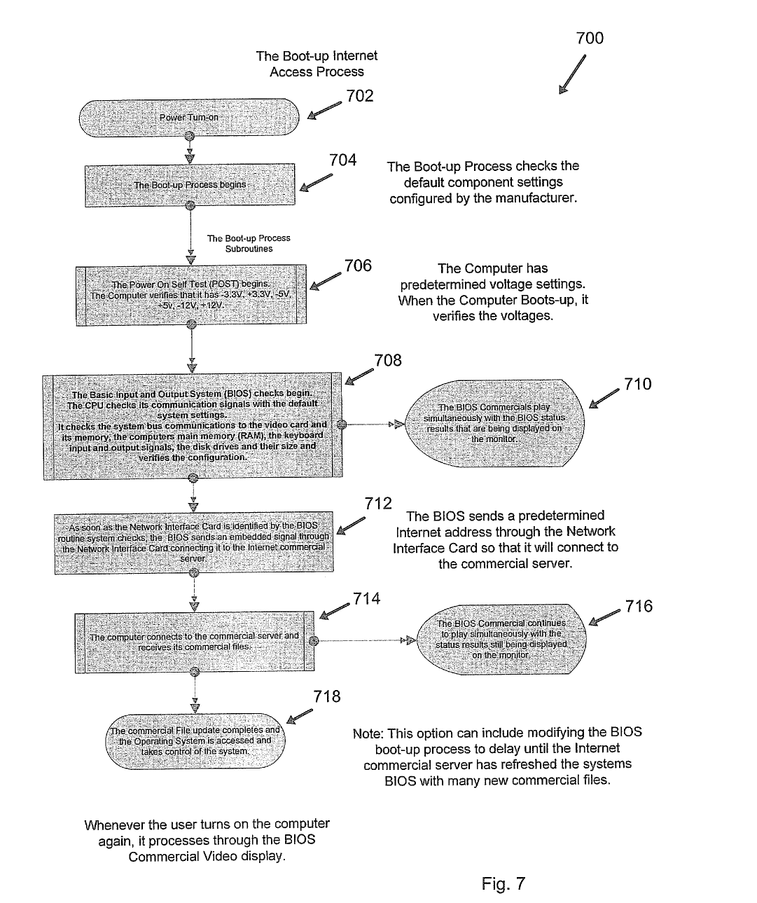

Referring to FIG. 7, an illustrative example of internet access capability which is triggered at boot-up 702. The boot-up process begins and the power on self test begins as reflected by functional blocks 704 and 706. The BIOS checks can also begin 708 and at this time the BIOS stored information media files can be displayed simultaneously 710. Further, as an alternative embodiment, when the network interface card is identified by the BIOS routine during system check, the BIOS can send an embedded signal through the network interface card where the signal is operable to command the network interface card to connect to the internet thereby establishing a connection to the commercial information media server. The BIOS can send a predetermined internet address through the network interface card so that it can connect 712 to the appropriate commercial information media server. The computer can therefore establish a link to the information media server and download and store information media files 714. During this time window when the BIOS system check is occurring and a link is established to the information media file server for downloading additional information media files the BIOS commercial or information media previously stored can continue to be displayed on the monitor 716. When the information media file update and the BIOS system check is complete 718 the operating system can be initiated to take control of the computing system and this option can include modifying the BIOS boot-up process to delay until the internet commercial server has refreshed the system's BIOS with new information media files. In addition, whenever the user turns on the computer again it will process the newly stored information media files by displaying them on the monitor.

The various electronic marketing examples shown above illustrates a novel apparatus and method for displaying advertisements during select time windows on a computing device. A user of the present invention may choose any of the above electronic marketing embodiments, or an equivalent thereof, depending upon the desired application. In this regard, it is recognized that various forms of the subject electronic marketing tool could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention. Other aspects, objects and advantages of the present invention can be obtained from a study of the drawings, the disclosure and the appended claims.

What is claimed is:

1. A computing device comprising:
a system BIOS including an information media file and display code executable at power up of the computing device where when said display code is executed at power up said display code functions to display the information media file on a monitor of the computing device in the foreground for user viewing during a BIOS/POST system time window and said display code further functions to cease displaying the information media file just prior initiating an OS of the computing device.

2. The computing device as recited in claim 1, where,
said system BIOS includes download code executable in the background during normal operation of the OS of the computing device where when said download code is executed in the background said download code controls the computing device to access a multimedia server remotely located with respect to the computing device and communicably linked to the computing device over a network and said download code controls the computing device to download information media files residing on the multimedia server.

3. The computing device as recited in claim 1, further comprising:
an API including executable download code that is executable in the background during normal operation of the computing device where when said download code is executed the API controls the computing device to access a multimedia server remotely located with respect to the computing device over a network and said download code controls the computing device to download the information media file residing on the multimedia server.

4. A method for electronically marketing an information media file comprising the steps of:
providing a system BIOS including an information media file and display code executable at power up of the computing device where when said display code is executed at power up, said display code functions to display the information media file on a monitor of the computing device in the foreground for user viewing during a BIOS/POST system time window and said display code further functions to cease displaying the information media file just prior initiating an OS of the computing device; and
executing the display code and displaying the information media file on the monitor.

5. The method as recited in claim 4, further comprising the steps of:
providing a system BIOS including download code executable in the background during normal operation of the OS of the computing device where when said download code is executed in the background said download code controls the computing device to access a multimedia server remotely located with respect to the computing device and communicably linked to the computing device over a network and said download code controls the computing device to download information media files residing on the multimedia server; and
executing the download code and downloading the information media file from a multimedia server.

6. The method as recited in claim 4, further comprising the step of:
providing an API including executable download code that is executable in the background during normal operation of the computing device where when said download code is executed the API controls the computing device to access a multimedia server remotely located with respect to the computing device over a network and said download code controls the computing device to download the information media file residing on the multimedia server; and
executing said download code and downloading the information media file.

7. A computing device comprising:
an API integral with an OS having executable access code and display code that is executable at power up of the computing device where when said API access code is executed at power up, an information media file stored in an inactive storage location of a peripheral device is accessed by the API and when said display code is executed the information media file is displayed just prior to initiating the OS of the computing device.

8. The computing device of claim 7, where,
said API includes executable download code that is executable in the background during normal operation of the computing device where when said download code is executed the API controls the computing device to access a multimedia server remotely located with respect to the computing device over a network and said download code controls the computing device to download the information media file residing on the multimedia server.

9. A method for electronically marketing an information file comprising the steps of:
providing an API having executable access code and display code that is executable at power up of the computing device where when said API access code is executed at power up an information media file stored in an inactive storage location of a peripheral device is accessed by the API and when said display code is executed the information media file is displayed just prior to initiating the OS of the computing device; and
executing said access and said display code.

10. The method as recited in claim 9, further comprising the steps of:
providing an API including executable download code that is executable in the background during normal operation of the computing device where when said download code is executed the API controls the computing device to access a multimedia server remotely located with respect to the computing device over a network and said download code controls the computing device to download the information media file residing on the multimedia server; and
executing said download code and downloading the information media file.
